(19) United States
(12) Patent Application Publication
(10) Pub. No.: US 2021/0341058 A1
(43) Pub. Date: Nov. 4, 2021

(54) METALLIC SEAL FOR VALVE ASSEMBLY

(71) Applicant: SAINT-GOBAIN PERFORMANCE PLASTICS CORPORATION, Solon, OH (US)

(72) Inventors: Andrea MAFFEZZOLI, MONZA (IT); Jan KUSTERMANS, Brecht (BE); Mark W. ARMITAGE, Madison, CT (US); Dimitri VAN DEN BROECK, Jodoigne (BE)

(21) Appl. No.: 17/306,139

(22) Filed: May 3, 2021

Related U.S. Application Data
(60) Provisional application No. 63/019,674, filed on May 4, 2020.

(51) Int. Cl. F16J 15/3212; F16J 15/02

(52) U.S. Cl. CPC F16J 15/3212; F16J 15/022

(57) ABSTRACT

Systems and methods include providing a seal for a valve assembly. The seal includes a metallic annular body having a main body portion, a first sealing leg extending from the main body portion and that provides an axial seal with a component in the valve assembly, and a second sealing leg extending from the main body portion that provides a radial seal with another component of the valve assembly. The seal may also include a sealing ring assembly having a sealing ring support and a sealing ring that forms a radial seal in conjunction with the sealing bumps of the second sealing leg.

### CROSS-REFERENCE TO RELATED APPLICATIONS

This application claims priority under 35 U.S.C. § 119(e) to U.S. Provisional Application No. 63/019,674, entitled “METALLIC SEAL FOR VALVE ASSEMBLY,” by Andrea MAFFEZZOLI et al., filed May 4, 2020, the disclosure of which is assigned to the current assignee hereof and incorporated herein by reference in its entirety for all purposes.

### BACKGROUND OF THE INVENTION

Valves are typically used to inhibit or facilitate the flow of a fluid in a wide range of applications. Many valves use seals or seal assemblies to prevent leakage through a valve housing, contain pressure within the housing, contain a desired substance within the housing, or exclude contamination from the housing. In some applications, valves may be subjected to extreme operating conditions, such as extreme temperatures and/or pressures. Seals used within valves subjected to such extreme operating conditions require higher reliability to properly maintain their sealing function without suffering excessive friction or wear. Accordingly, the industry continues to demand improvements in seal technology for such applications.

### BRIEF DESCRIPTION OF THE DRAWINGS

So that the manner in which the features and advantages of the embodiments are attained and can be understood in more detail, a more particular description may be had by reference to the embodiments thereof that are illustrated in the appended drawings. However, the drawings illustrate only some embodiments and therefore are not to be considered limiting in scope as there may be other equally effective embodiments.

FIG. 1 is a cross-sectional view of a seal according to an embodiment of the disclosure.

FIG. 2 is an oblique view of a seal according to an embodiment of the disclosure.

FIG. 3 is a cross-sectional view of a valve having a seal according to an embodiment of the disclosure.

FIG. 4 is a flowchart of a method of forming a seal in an assembly according to an embodiment of the disclosure.

FIG. 5 shows a cross-sectional view of the pressure distribution of a seal disposed in an assembly according to an embodiment of the disclosure.

FIG. 6 is a chart of contact length of a second sealing leg of a seal against contact pressure for a series of pressure cycles according to an embodiment of the disclosure.

FIG. 7 is a chart of contact force of a second sealing leg of a seal against each of three pressure cycles according to an embodiment of the disclosure.

The use of the same reference symbols in different drawings indicates similar or identical items.

### DETAILED DESCRIPTION

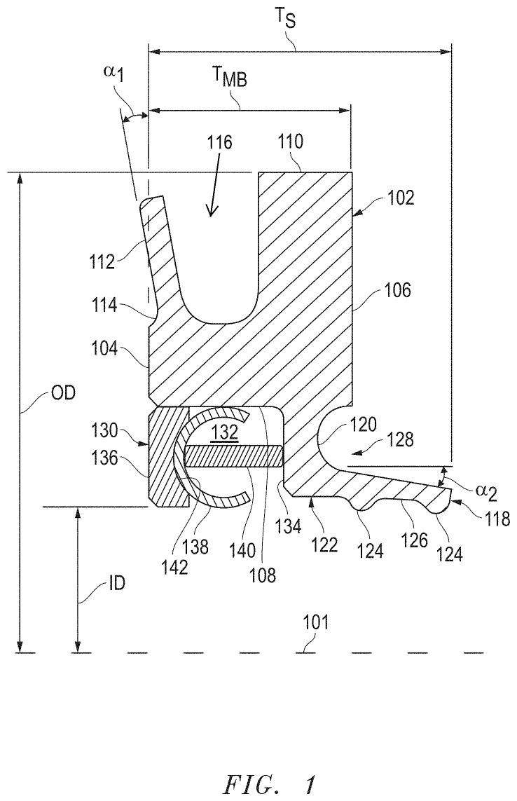

FIG. 1 shows a cross-sectional view of a seal 100 according to an embodiment of the disclosure. The seal 100 may generally comprise an annular seal having a nominal inner diameter (ID) and a nominal outer diameter (OD) with respect to a central axis 101 of the seal 100. The seal 100 may comprise a metallic annular body having a main body portion 102, a first sealing leg 112, and a second sealing leg 118. The main body portion 202 may comprise a first radial surface 104 and a second radial surface 106 opposite the first radial surface. In some embodiments, the first radial surface 104 and the second radial surface 106 may define a nominal axial thickness (T_{MB}) of the main body portion 102. In some embodiments, depending on the configuration and/or orientation of the seal 100, the first radial surface 104 and the second radial surface 106 may define top and bottom surfaces of the seal 100 within an assembly. The main body portion 102 may comprise an inner annular surface 108 and an outer annular surface 110 opposite the inner annular surface 108. In some embodiments, the outer annular surface 110 may define the nominal outer diameter (OD) of the seal 100. Further, in some embodiments, the inner annular surface 108 and/or the outer annular surface 110 may be substantially parallel to the axis 101 of the seal 100.

The seal 100 may comprise a first sealing leg 112 that is integral with the main body portion 102. The first sealing leg 112 may extend from the main body portion 102 adjacent to the first radial surface 104. In some embodiments, the first sealing leg 112 may extend radially from the main body portion 102 at an angle (α₁) that is not parallel to the first radial surface 104 and/or that is not orthogonal to the axis 101 of the seal 100. In some embodiments, the first sealing leg 112 may extend from the main body portion 102 at an angle (α₁) of at least 1 degree, at least 2 degrees, at least 3 degrees, at least 4 degrees, at least 5 degrees, at least 10 degrees, at least 15 degrees, at least 20 degrees, at least 25 degrees, or at least 30 degrees. In some embodiments, the first sealing leg 112 may extend from the main body portion 102 at an angle (α₁) of not greater than 45 degrees, not greater than 40 degrees, 35 degrees, not greater than 30 degrees, not greater than 25 degrees, not greater than 20 degrees, or not greater than 15 degrees. Further, it will be appreciated that the first sealing leg 112 may extend from the main body portion 112 at an angle (α₁) between any of these minimum and maximum values, such as at least 1 degree to not greater than 45 degrees, or even at least 5 degrees to not greater than 15 degrees.

In some embodiments, the first sealing leg 112 may extend beyond the nominal axial thickness (T_{MB}) of the main body portion 102 and/or outwardly beyond the first radial surface 104. In some embodiments, the first sealing leg 112 may extend beyond the nominal axial thickness (T_{MB}) of the main body portion 102 and/or outwardly beyond the first radial surface 104 by at least 0.05 mm, at least 0.10 mm, at least 0.15 mm, at least 0.20 mm, at least 0.25 mm, or at least 0.30 mm. In some embodiments, the first sealing leg 112 may extend beyond the nominal axial thickness (T_{MB}) of the main body portion 102 and/or outwardly beyond the first radial surface 104 by not greater than 3 mm, not greater than 2 mm, not greater than 1 mm, not greater than 0.75 mm, or not greater than 0.50 mm. Further, it will be appreciated that the first sealing leg 112 may extend beyond the nominal axial thickness (T_{MB}) of the main body portion 102 and/or outwardly beyond the first radial surface 104 between any of these minimum and maximum values, such as at least 0.05 mm to not greater than 3 mm, or even at least 0.15 mm to not greater than 0.5 mm.

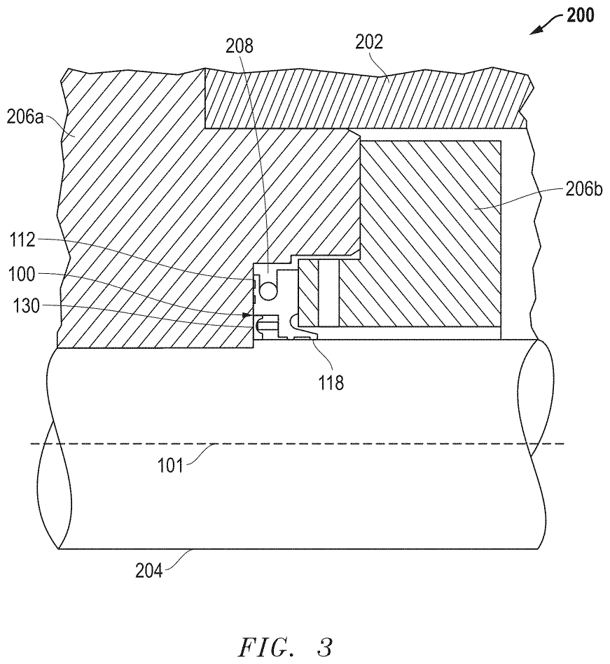

By extending at an angle (α₁) from the main body portion 112 and beyond the nominal axial thickness (T_{MB}) of the main body portion 102 and/or outwardly beyond the first radial surface 104, the first sealing leg 112 may increase the contact (“sealing”) pressure to form an axial seal within an assembly. In some embodiments, the first sealing leg 112 may comprise a constant width along a length of the first sealing leg 112. However, in some embodiments, the first sealing leg 112 may comprise a tapered width along the length of the first sealing leg 112. Furthermore, in some embodiments, the seal 100 may comprise a radiused recess 114 adjacent to the first radial surface 104 and the first sealing leg 112. Accordingly, in some embodiments, this may allow less than an entirety of the first sealing leg 112 to contact a portion of an assembly, which may reduce the contact surface area of the first sealing leg 112 with a portion of an assembly. In some embodiments, the first sealing leg 112 may form a radiused cavity 116 with the main body portion 102 adjacent to the outer annular surface 110 of the seal 100. In some embodiments, a metallic U-shaped, O-shaped, D-shaped, or C-shaped ring or spring may be disposed within the radiused cavity 116. In some embodiments, the radiused cavity 116 may be formed such that the first sealing leg 112 does not contact the main body portion 102 when installed in an assembly. In some embodiments, the radiused cavity 116 may provide additional strength to the first sealing leg 112. In some embodiments, the radiused cavity 116 may increase the resiliency of the first sealing leg 112 and/or the seal 100 as a whole. Furthermore, in some embodiments, the radiused cavity 116 may enable the seal 100 to maintain sufficient contact pressure with one or more hardware components (such as one or more of bonnet 206a, 206b in FIG. 3) over a minimum number of pressure cycles to provide the seal 100 with sufficient reliability and/or an extended service life over traditional seals.

The seal 100 may comprise a second sealing leg 118 that is integral with the main body portion 102. The second sealing leg 118 may comprise a first leg portion 120 that extends radially inward from inner annular surface 108 and a second leg portion 122 integral with and extending axially from first leg portion 120. In some embodiments, the first leg portion 120 may extend orthogonally from the main body portion 102. In some embodiments, the first leg portion 120 may extend orthogonally from the inner annular surface 108 of the main body portion 102 and/or with respect to the axis of the seal 100.

In some embodiments, the second leg portion 122 may extend from the first leg portion 120 at an angle (α₂) that is not orthogonal to the first leg portion 120 and/or that is not parallel to the inner annular surface 108 and/or the axis 101 of the seal 100. In some embodiments, the second leg portion 122 may extend from the first leg portion 120 at an angle (α₂) of at least 1 degree, at least 2 degrees, at least 3 degrees, at least 4 degrees, at least 5 degrees, at least 10 degrees, at least 15 degrees, at least 20 degrees, at least 25 degrees, or at least 30 degrees. In some embodiments, the second leg portion 122 may extend from the first leg portion 120 at an angle (α₂) of not greater than 45 degrees, not greater than 40 degrees, 35 degrees, not greater than 30 degrees, not greater than 25 degrees, not greater than 20 degrees, or not greater than 15 degrees. Further, it will be appreciated that the second leg portion 122 may extend from the first leg portion 120 at an angle (α₂) between any of these minimum and maximum values, such as at least 1 degree to not greater than 45 degrees, or even at least 5 degrees to not greater than 15 degrees.

In some embodiments, the second leg portion 122 may comprise one or more sealing bumps 124 extending radially inward from an inner annular surface 126 of the second leg portion 122. In a particular embodiment, a first sealing bump 124 may be disposed on the inner annular surface 126 adjacent to the distal end of second leg portion 122, and a second sealing bump 124 may be disposed on the inner annular surface 126 spaced away from the distal end of second leg portion 122. The one or more sealing bumps 124 may form annular ridges about the inner annular surface 126 of the second leg portion 122. The one or more sealing bumps 124 may provide redundancy in the event one or more sealing bumps 124 become damaged during installation in and/or operation of an assembly. In some embodiments, the second leg portion 122 may comprise at least 1, at least one pair or at least 2, at least 3, at least 4, or at least 5 sealing bumps 124. In some embodiments, the second leg portion 122 may comprise not greater than 10, not greater than 9, not greater than 8, not greater than 7, not greater than 6, not greater than 5, not greater than 4, or not greater than 3 sealing bumps 124. Further, it will be appreciated that the second leg portion 122 may comprise any number of sealing bumps 124 between any of these minimum and maximum values, such as at least 1 to not greater than 10 sealing bumps 124, or even at least one pair to not greater than 5 sealing bumps 124.

In some embodiments, the second leg portion 122 and/or one or more of the sealing bumps 124 may extend beyond the nominal inner diameter (ID) of the seal 100. In some embodiments, the second leg portion 122 and/or one or more of the sealing bumps 124 may extend beyond the nominal inner diameter (ID) of the seal 100 by at least 0.05 mm, at least 0.10 mm, at least 0.15 mm, at least 0.20 mm, at least 0.25 mm, or at least 0.30 mm. In some embodiments, the second leg portion 122 and/or one or more of the sealing bumps 124 may extend beyond the nominal inner diameter (ID) of the seal 100 by not greater than 3 mm, not greater than 2 mm, not greater than 1 mm, not greater than 0.75 mm, or not greater than 0.50 mm. Further, it will be appreciated that the second leg portion 122 and/or one or more of the sealing bumps 124 may extend beyond the nominal inner diameter (ID) of the seal 100 between any of these minimum and maximum values, such as at least 0.05 mm to not greater than 3 mm, or even at least 0.15 mm to not greater than 0.5 mm.

By extending beyond the nominal inner diameter (ID) of the seal 100, the second leg portion 122 and/or the sealing bumps 124 may increase contact (“sealing”) pressure, reduce a contact area, and/or increase wear resistance as compared to a smooth sealing leg not having any sealing bumps 124 to form a radial seal within an assembly. In some embodiments, the second leg portion 122 may comprise a constant width along a length of the second leg portion 122. However, in some embodiments, the second leg portion 122 may comprise a tapered width along the length of the second leg portion 122. Furthermore, in some embodiments, the seal 100 may comprise a radiused cavity 128 adjacent to the second radial surface 106 and formed by the second sealing leg 118. In some embodiments, the radiused cavity 128 may provide additional strength to the first leg portion 120 of the second sealing leg 118. In some embodiments, the radiused cavity 128 may increase the resiliency of the second sealing leg 118 and/or the seal 100 as a whole. Furthermore, in some embodiments, the radiused cavity 128 may enable the seal 100 to maintain a sufficient contact pressure with a hardware component (such as shaft 204 in FIG. 3) over a minimum number of pressure cycles to provide the seal 100 with sufficient reliability and/or an extended service life over traditional seals.

The seal 100 may also comprise a sealing ring assembly 130. The sealing ring assembly 130 may function to provide further sealing redundancy, such that the sealing ring assembly 130 forms a radial seal in conjunction with the second sealing leg 118 and/or the sealing bumps 124 of the second sealing leg 118. The sealing ring assembly 130 may comprise a ring support 136 and a sealing ring 138. In some embodiments, the sealing ring assembly 130 may also comprise an insert 140. The sealing ring assembly 130 may generally be received within an inner annular cavity 132 that is formed by the inner annular surface 108 and a radial surface 134 of the first leg portion 120 of the second sealing leg 118. In some embodiments, the sealing ring assembly 130 may comprise a slight interference fit with the inner annular cavity 132. This fit may allow the sealing assembly to be press fit into and retained within the inner annular cavity 132 of the seal 100. In some embodiments, the sealing ring assembly 130 may be received within an inner annular cavity 132 such that the ring support 136 may be substantially co-planar with the first radial surface 104. However, in other embodiments, the sealing ring assembly 130 may comprise any thickness that does not protrude beyond the first radial surface 104 of the seal 100.

The ring support 136 may generally comprise an inner surface 142 that is complementary to and at least partially receives the sealing ring 138. In some embodiments, the sealing ring 138 may comprise a C-shaped ring. In other embodiments, the sealing ring 138 may comprise a U-shaped ring, an O-shaped ring, a D-shaped ring, or any other shaped ring. The insert 140 may generally be disposed between an inner curved portion of the sealing ring 138 and the first leg portion 120 of the second sealing leg 118. In some embodiments, the insert 140 may function to keep the sealing ring 138 properly oriented and/or positioned within the inner annular cavity 132. However, in some embodiments, the sealing ring assembly 130 may not comprise an insert 140.

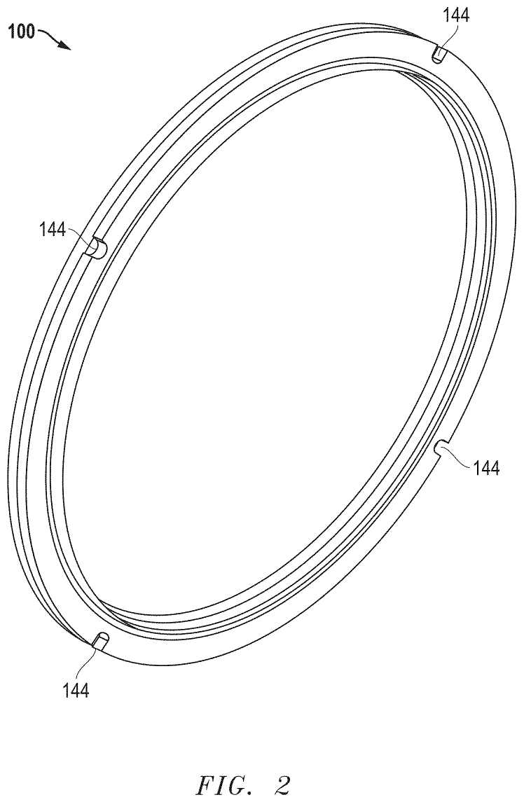

FIG. 2 shows an oblique view of the seal 100 according to an embodiment of the disclosure. In some embodiments. The seal 100 may comprise a plurality of notches 144 disposed through the main body portion 102 of the seal. In some embodiments, the notches 144 may generally be configured to receive a fastener therethrough or engage a component or feature within an assembly to prevent rotation of the seal 100 within the assembly. In other embodiments, the notches 144 may be configured for mechanical attachment to a component or feature within an assembly through mechanical attachment, mechanical deformation (e.g., crimping or splines), adhesive, welding, or any other suitable manner.

The seal 100 may generally comprise a metallic seal configured to form a metal-to-metal seal within an assembly. In some embodiments, the main components of the seal 100 (e.g., the main body portion 102, the first sealing leg 112, and the second sealing leg 118) may be formed from a metal or alloy. In some embodiments, the metallic annular body (e.g., the main body portion 102, the first sealing leg 112, and the second sealing leg 118) of the seal 100 may be formed from a nickel-chromium based alloy such as Inconel®, a nickel-based alloy, nickel, titanium, tungsten, stainless steel, spring steel, steel, aluminum, zinc, copper, magnesium, tin, platinum, lead, iron, or bronze. Further, in some embodiments, the metallic annular body (e.g., the main body portion 102, the first sealing leg 112, and the second sealing leg 118) of the seal 100 may comprise a coating. In some embodiments, the coating may comprise an aluminum chromium nitride (AlCrN) coating or a titanium aluminum nitride (TiAlN) coating. However, in other embodiments, the coating may comprise any other suitable coating.

In some embodiments, the components of the sealing ring assembly 130 (e.g., the ring support 136, the sealing ring 138, and the insert 140) may be formed from a metal or alloy. In some embodiments, the components of the sealing ring assembly 130 (e.g., the ring support 136, the sealing ring 138, and the insert 140) may be formed from the same or a similar material as the metallic annular body (e.g., the main body portion 102, the first sealing leg 112, and the second sealing leg 118) of the seal 100. In some embodiments, the components of the sealing ring assembly 130 (e.g., the ring support 136, the sealing ring 138, and the insert 140) may be formed from a nickel-chromium based alloy such as Inconel®, a nickel-based alloy, nickel, titanium, tungsten, stainless steel, spring steel, steel, aluminum, zinc, copper, magnesium, tin, platinum, lead, iron, or bronze. Further, in some embodiments, one or more of the components of the sealing ring assembly 130 (e.g., the ring support 136, the sealing ring 138, and the insert 140) may comprise a coating. In some embodiments, the coating may comprise a gold strike coating. In other embodiments, the coating may comprise an aluminum chromium nitride (AlCrN) coating or a titanium aluminum nitride (TiAlN) coating. However, in other embodiments, the coating may comprise any other suitable coating.

FIG. 3 is a cross-sectional view of an assembly 200 having a seal 100 according to an embodiment of the disclosure. The seal 100 may be used in an assembly 200 and disposed about the axis 101. In some embodiments, the assembly 200 may be a valve assembly. In more specific embodiments, the assembly 200 may be a ball valve assembly. In a number of more specific embodiments, the assembly 200 may be a subsea valve or subsea valve assembly. The assembly may generally comprise a housing 202 and at least one stem or shaft 204 disposed along the axis 101. In some embodiments, the assembly 200 or housing 202 may include one or more bonnets 206. The one or more bonnets 206 may generally comprise an annular body disposed about the axis 101. In some embodiments, the assembly 200 or housing 202 may comprise a first bonnet 206a and a second bonnet 206b. The stem 204 may extend axially through at least one of the first bonnet 206a or the second bonnet 206b. The assembly 200 may also comprise an annular cavity 208 configured to receive the seal 100 therein. In some embodiments, the annular cavity 208 may be formed in the housing 202, the first bonnet 206a, or the second bonnet 206b.

The seal 100 may be configured to contact and provide a seal with components (e.g., housing 202, shaft 204, first bonnet 206a, and/or second bonnet 206b) of the assembly 200. In some embodiments, the first sealing leg 112 and the second sealing leg 118 may be configured to provide a seal with the housing 202, the shaft 204, the first bonnet 206a, and/or the second bonnet 206b. In some embodiments, the first sealing leg 112 may be configured to contact and provide a radial seal with the first bonnet 206a. In some embodiments, the first sealing leg 112 may deflect, flex, or otherwise be displaced with respect to the main body portion 102 of the seal 100 when contact with the first bonnet 206a occurs. In some embodiments, the second sealing leg 118 may be configured to contact and provide an axial seal with the shaft 204. In some embodiments, the second sealing leg 118 may deflect, flex, or otherwise be displaced with respect to the main body portion 102 of the seal 100 when contact with the shaft 204 occurs. Further, in some embodiments, the main body portion 102, and more specifically, the second radial surface 106 may be configured to contact the second bonnet 206b. In some embodiments, both the first sealing leg 112 and the second sealing leg 118 may be configured to deflect to provide a seal in both a radial and an axial direction, respectively, relative to the seal 100. It will be appreciated that in some embodiments, the assembly 200 may include additional components, including, but not limited to, a ball member, a first passageway to the assembly 200, a second passageway from the assembly 200, and/or one or more U-shaped rings, O-shaped rings, D-shaped rings, C-shaped rings, or any other shaped ring disposed in one or more cavities of the seal 100.

The seal 100 may generally be configured for operation in a wide variety of applications. For example, in some embodiments, the seal 100 may be configured to be used to seal about a shaft 204 having a diameter of at least 75 mm (about 3 inches) to at least 200 millimeters (about 8 inches). As such, it will be appreciated that the dimensions of the seal 100 may be scaled and/or sized appropriately based on the “size” of the assembly 200 and/or the shaft 204.

In some embodiments, the nominal inner diameter (ID) of the seal 100 may be at least 1 mm, at least 5 mm, at least 10 mm, at least 25 mm, at least 50 mm, at least 75 mm, at least 100 mm, at least 150 mm, at least 200 mm, at least 250 mm, at least 300 mm, or even greater.

In some embodiments, the nominal outer diameter (OD) of the seal 100 may be at least 1 mm, 5 mm, at least 10 mm, at least 25 mm, at least 50 mm, at least 75 mm, at least 100 mm, at least 150 mm, at least 200 mm, at least 250 mm, at least 300 mm, at least 500 mm, or even greater.

In some embodiments, the nominal axial thickness (T_{MB}) of the main body portion 102 may be at least 1 mm, at least 2 mm, at least 3 mm, at least 4 mm, at least 5 mm, at least 6 mm, at least 7 mm, at least 8 mm, at least 9 mm, at least 10 mm, at least 15 mm, at least 20 mm, at least 25 mm, or even greater.

In some embodiments, the nominal axial thickness (T_{S}) of the seal 100 may be at least 1 mm, at least 2 mm, at least 3 mm, at least 4 mm, at least 5 mm, at least 6 mm, at least 7 mm, at least 8 mm, at least 9 mm, at least 10 mm, at least 15 mm, at least 20 mm, at least 25 mm, or even greater.

In some embodiments, a ratio of the nominal axial thickness (T_{MB}) of the main body portion 102 to the nominal axial thickness (T_{S}) of the seal 100 may be at least 1:1.1, at least 1:1.2, at least 1:1.3, at least 1:1.4, or at least 1:1.5. In some embodiments, the ratio of the nominal axial thickness (T_{MB}) of the main body portion 102 to the nominal axial thickness (T_{S}) of the seal 100 may be not greater than 1:3, not greater than 1:2.75, not greater than 1:2.5, not greater than 1:2.25, or not greater than 1:2. Further, it will be appreciated that the ratio of the nominal axial thickness (T_{MB}) of the main body portion 102 to the nominal axial thickness (T_{S}) of the seal 100 may be between any of these minimum and maximum values, such as at least 1:1.1 to not greater than 1:3, or even at least 1:1.4 to not greater than 1:2.

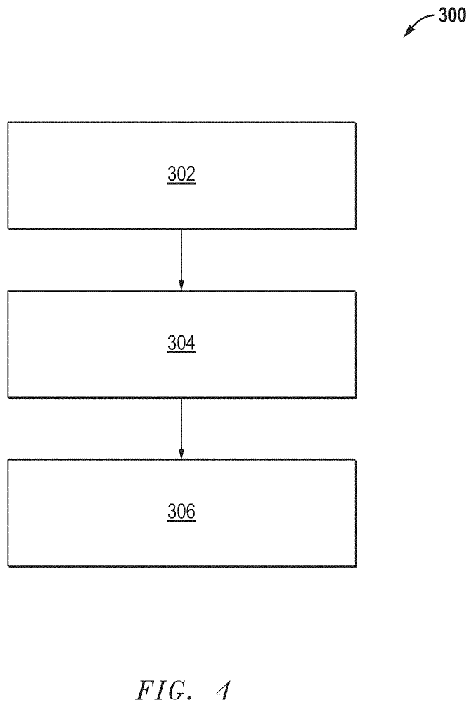

FIG. 4 is a flowchart of a method 300 of forming a seal in an assembly 200 according to an embodiment of the disclosure. The method 300 may begin at block 302 by providing an assembly 200 having an axis 101, a shaft 204, and at least one bonnet 206 disposed annularly about the shaft 204. The method 300 may continue at block 304 by providing a seal 100 comprising a metallic annular body, comprising: a main body portion 102; a first sealing leg 112 extending from the main body portion 102 and configured to provide an axial seal with the at least one bonnet 206; and a second sealing leg 118 extending from the main body portion 102 and comprising at least one pair of sealing bumps 124 configured to provide a radial seal with the shaft 204. The method 300 may continue at block 306 by disposing the seal 100 within the assembly 200 such that the first sealing leg 112 contacts the at least one bonnet and forms a radial seal with the at least one bonnet and such that the second sealing leg 118 contacts the shaft 204 and forms an axial seal with the at least one shaft 204. In some embodiments, disposing the seal 100 within the assembly 200 may further comprise disposing the seal 100 within an annular cavity 208 formed in the at least one bonnet 206. In some embodiments, disposing the seal 100 within the assembly 200 may further comprise deflecting, flexing, or otherwise displacing at least one of the first sealing leg 112 axially and the second sealing leg 118 radially with respect to the main body portion 102 of the seal 100. In some embodiments, disposing the seal 100 within the assembly 200 may further comprise deflecting, flexing, or otherwise displacing the first sealing leg 112 axially and the second sealing leg 118 radially with respect to the main body portion 102 of the seal 100.

### EXAMPLES

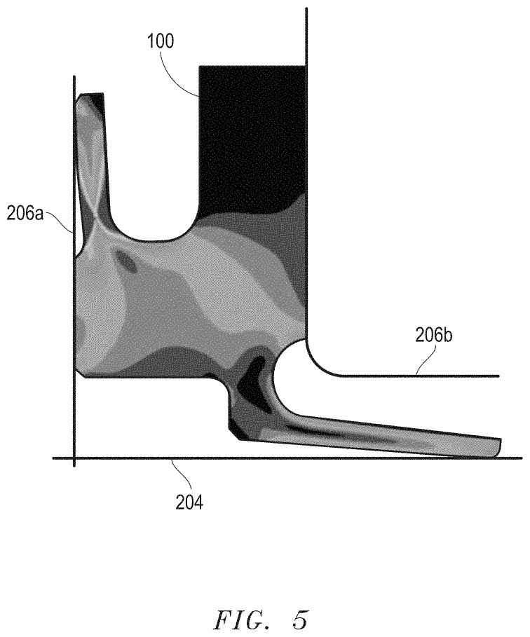

FIG. 5 shows a cross-sectional view of the pressure distribution of a seal 100 disposed in an assembly 200 according to an embodiment of the disclosure. The seal 100 is shown installed about the shaft 204 and disposed between the opposing bonnets 206a, 206b. The pressure distribution may generally represent the preloaded forces or pressures acting upon the seal 100 after installation. Accordingly, the seal 100 is shown in a static state (without an externally applied force or pressure as a result of operating the assembly 200), installed about the shaft 204, and disposed between the opposing bonnets 206a, 206b.

FIG. 6 shows a chart of contact length of the second sealing leg 118 of the seal 100 against contact pressure of the second sealing leg 118 of the seal 100 for a series of pressure cycles according to an embodiment of the disclosure. The seal 100 was subjected to a series of pressure cycles, each cycle starting at 0 bar and increasing to 1035 bar, then decreasing from 1035 bar to 0 bar. During each cycle, the contact length of the second sealing leg 118 of the seal 100 was measured, and the contact pressure of the second sealing leg 118 of the seal was measured.

As shown in FIG. 6, the contact length of the second sealing leg 118 of the seal 100 during the first pressure cycle as measured at a pressure of 250 bar was 0.097 mm with a contact pressure against the shaft 204 of about 1400 MPa. The contact length of the second sealing leg 118 of the seal 100 during the second pressure cycle as measured at a pressure of 250 bar was 0.85 mm with a contact pressure against the shaft 204 of about 180 MPa. The contact length of the third pressure cycle as measured at a pressure of 250 bar was 1.25 mm with a contact pressure against the shaft 204 of about 180 MPa. Common in traditional seals through subsequent pressure cycles is a reduction in contact pressure and a corresponding reduction in contact length which results in unsatisfactory leakage of traditional seals. Seal 100 demonstrated a reduction in contact pressure after the first pressure cycle and during the second pressure cycle and exhibited a reduction in contact length. In some embodiments, the reduction in contact length during the first cycle may be due to the minimal contact length present upon installation. Seal 100 further maintained contact pressure after the second pressure cycle and during the third pressure cycle, while demonstrating an increase in contact length. This increase in contact length enables the seal 100 to maintain a substantially consistent, predictable, and/or reliable fluid tight seal within the assembly 100.

Accordingly, in some embodiments, the seal 100 may maintain a substantially constant contact length during subsequent pressure cycles after being subjected to a series of pressure cycles of a pressure of at least 250 bar, at least 500 bar, at least 750 bar, or at least 1000 bar. In some embodiments, the seal 100 may experience a reduction in contact length of not greater than 15%, not greater than 14%, not greater than 13%, not greater than 12%, not greater than 11%, not greater than 10%, or even not greater than 5% after being subjected to a series of pressure cycles of a pressure of at least 250 bar, at least 500 bar, at least 750 bar, or at least 1000 bar. However, in some embodiments, the seal 100 may actually demonstrate an increase in contact length after being subjected to a series of pressure cycles of a pressure of at least 250 bar, at least 500 bar, at least 750 bar, or at least 1000 bar. In some embodiments, the seal 100 may achieve these contact length results for a minimum number of pressure cycles of at least 3 cycles, at least 4 cycles, at least 5 cycles, at least 10 cycles, at least 25 cycles, at least 50 cycles, at least 100 cycles, at least 500 cycles, or at least 100 cycles.

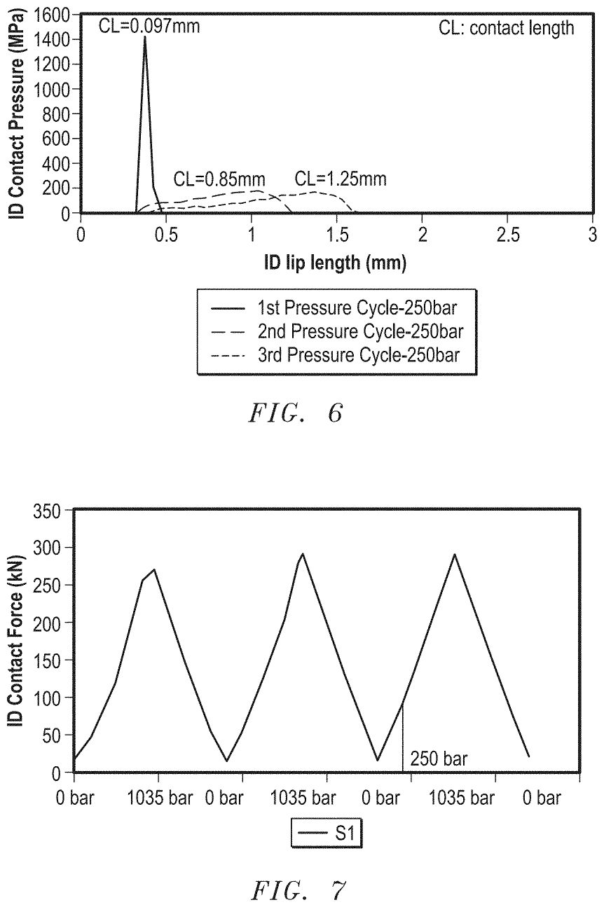

FIG. 7 shows a chart of contact force of the second sealing leg 118 of the seal 100 against each of three pressure cycles according to an embodiment of the disclosure. As shown in FIG. 7, the second sealing leg 118 of the seal 100 maintains a substantially constant performance (contact force with respect to pressure) over the subsequent pressure cycles. Comparatively, traditional seals may demonstrate a reduction in contact force during subsequent cycles caused by the aforementioned reduction in contact pressure and a corresponding reduction in contact length, which therefore results in unsatisfactory leakage of traditional seals. However, the seal 100 maintains sufficient contact force over the series of pressure cycles, while increasing the contact length of the second sealing leg 118 of the seal 100. Furthermore, in some embodiments, the first sealing leg 116 of the seal 100 may also exhibit substantially similar performance of maintaining or increasing contact length while also maintaining a substantially constant performance (contact force with respect to pressure) during subsequent pressure cycles. Thus, the seal 100 is able to outperform traditional seals in reliability and sealing behavior over a series of pressure cycles to provide the seal 100 with sufficient reliability and/or an extended service life over traditional seals.

Embodiments of a seal 100, an assembly 200, and/or method of forming a seal in an assembly 200 may include one or more of the following:

Embodiment 1. A seal, comprising: a metallic annular body, comprising: a main body portion; a first sealing leg extending from the main body portion and configured to provide an axial seal; and a second sealing leg extending from the main body portion and comprising at least one pair of sealing bumps configured to provide a radial seal.

Embodiment 2. An assembly, comprising: a valve comprising an axis, a shaft, and at least one bonnet disposed annularly about the shaft; a seal comprising a metallic annular body, comprising: a main body portion; a first sealing leg extending from the main body portion and configured to provide an axial seal with the at least one bonnet; and a second sealing leg extending from the main body portion and comprising at least one pair of sealing bumps configured to provide a radial seal with the shaft.

Embodiment 3. The seal of Embodiment 1 or the assembly of Embodiment 2, wherein the first sealing leg and the second sealing leg are integral with the main body portion.

Embodiment 4. The seal or the assembly of any of Embodiments 1 to 3, wherein the first sealing leg seals independently of the second sealing leg.

Embodiment 5. The seal or the assembly of any of Embodiments 1 to 4, wherein the first sealing leg extends from the main body portion adjacent to a first radial surface of the main body portion.

Embodiment 6. The seal or the assembly of Embodiment 5, wherein the seal comprises a radiused recess adjacent to the first radial surface and the first sealing leg.

Embodiment 7. The seal or the assembly of any of Embodiments 1 to 6, wherein the first sealing leg extends radially from the main body portion at an angle (al) of at least 1 degree, at least 2 degrees, at least 3 degrees, at least 4 degrees, at least 5 degrees, at least 10 degrees, at least 15 degrees, at least 20 degrees, at least 25 degrees, or at least 30 degrees.

Embodiment 8. The seal or the assembly of Embodiment 7, wherein the first sealing leg extends from the main body portion at an angle (al) of not greater than 45 degrees, not greater than 40 degrees, 35 degrees, not greater than 30 degrees, not greater than 25 degrees, not greater than 20 degrees, or not greater than 15 degrees.

Embodiment 9. The seal or the assembly of any of Embodiments 1 to 8, wherein the first sealing leg extends beyond a nominal axial thickness (TMB) of the main body portion.

Embodiment 10. The seal or the assembly of Embodiment 9, wherein the first sealing leg extends beyond the nominal axial thickness (TMB) of the main body portion by at least 0.05 mm, at least 0.10 mm, at least 0.15 mm, at least 0.20 mm, at least 0.25 mm, or at least 0.30 mm.

Embodiment 11. The seal or the assembly of Embodiment 10, wherein the first sealing leg extends beyond the nominal axial thickness (TMB) of the main body portion by not greater than 3 mm, not greater than 2 mm, not greater than 1 mm, not greater than 0.75 mm, or not greater than 0.50 mm.

Embodiment 12. The seal or the assembly of any of Embodiments 1 to 11, wherein the first sealing leg forms a radiused cavity with the main body portion adjacent to an outer annular surface of the main body portion.

Embodiment 13. The seal or the assembly of any of Embodiments 1 to 12, wherein a metallic U-shaped, O-shaped, D-shaped, or C-shaped ring or spring is disposed within the radiused cavity.

Embodiment 14. The seal or the assembly of any of Embodiments 1 to 13, wherein the second sealing leg comprises a first leg portion that extends radially inward from an inner annular surface of the main body portion.

Embodiment 15. The seal or the assembly of Embodiment 14, wherein the first leg portion extends orthogonally from the main body portion.

Embodiment 16. The seal or the assembly of Embodiment 15, wherein the second sealing leg comprises a second leg portion integral with and extending axially from the first leg portion.

Embodiment 17. The seal or the assembly of Embodiment 16, wherein the second leg portion extends from the first leg portion at an angle (α2) of at least 1 degree, at least 2 degrees, at least 3 degrees, at least 4 degrees, at least 5 degrees, at least 10 degrees, at least 15 degrees, at least 20 degrees, at least 25 degrees, or at least 30 degrees.

Embodiment 18. The seal or the assembly of Embodiment 17, wherein the second leg portion extends from the first leg portion at an angle (α2) of not greater than 45 degrees, not greater than 40 degrees, 35 degrees, not greater than 30 degrees, not greater than 25 degrees, not greater than 20 degrees, or not greater than 15 degrees.

Embodiment 19. The seal or the assembly of any of Embodiments 1 to 18, wherein the sealing bumps extend radially inward from an inner annular surface of the second leg portion.

Embodiment 20. The seal or the assembly of Embodiment 19, wherein a first sealing bump is disposed on the inner annular surface adjacent to a distal end of the second leg portion, and wherein a second sealing bump is disposed on the inner annular surface spaced away from the distal end of the second leg portion.

Embodiment 21. The seal or the assembly of Embodiment 20, wherein the sealing bumps form annular ridges about the inner annular surface of the second leg portion.

Embodiment 22. The seal or the assembly of any of Embodiments 14 to 21, wherein the second leg portion comprises at least 3, at least 4, or at least 5 sealing bumps.

Embodiment 23. The seal or the assembly of Embodiment 22, wherein the second leg portion comprises not greater than 10, not greater than 9, not greater than 8, not greater than 7, not greater than 6, not greater than 5, not greater than 4, or not greater than 3 sealing bumps.

Embodiment 24. The seal or the assembly of any of Embodiments 14 to 23, wherein one or more of the sealing bumps extends beyond a nominal inner diameter (ID) of the seal.

Embodiment 25. The seal or the assembly of Embodiment 24, wherein one or more of the sealing bumps extends beyond a nominal inner diameter (ID) of the seal by at least 0.05 mm, at least 0.10 mm, at least 0.15 mm, at least 0.20 mm, at least 0.25 mm, or at least 0.30 mm.

Embodiment 26. The seal or the assembly of Embodiment 25, wherein one or more of the sealing bumps extends beyond a nominal inner diameter (ID) of the seal by not greater than 3 mm, not greater than 2 mm, not greater than 1 mm, not greater than 0.75 mm, or not greater than 0.50 mm.

Embodiment 27. The seal or the assembly of any of Embodiments 14 to 26, wherein the sealing bumps increase contact (“sealing”) pressure, reduce a contact area, and increase wear resistance as compared to a smooth sealing leg not having any sealing bumps.

Embodiment 28. The seal or the assembly of any of Embodiments 14 to 27, wherein the seal comprises a radiused cavity adjacent to a second radial surface of the main body portion and formed by the second sealing leg.

Embodiment 29. The seal or the assembly of any of Embodiments 1 to 28, wherein the seal comprises a sealing ring assembly.

Embodiment 30. The seal or the assembly of Embodiment 29, wherein the sealing ring assembly forms a radial seal in conjunction with the sealing bumps of the second sealing leg.

Embodiment 31. The seal or the assembly of any of Embodiments 29 to 30, wherein the sealing ring assembly is received within an inner annular cavity that is formed by an inner annular surface of the main body portion and a radial surface of the first leg portion of the second sealing leg.

Embodiment 32. The seal or the assembly of any of Embodiments 29 to 31, wherein the sealing ring assembly comprises a ring support, a sealing ring, and an insert.

Embodiment 33. The seal or the assembly of Embodiment 32, wherein the ring support comprises an inner surface that is complementary to and at least partially receives the sealing ring.

Embodiment 34. The seal or the assembly of any of Embodiments 32 to 33, wherein the sealing ring comprises a C-shaped ring, U-shaped ring, an O-shaped ring, a D-shaped ring, or any other shaped ring.

Embodiment 35. The seal or the assembly of any of Embodiments 32 to 34, wherein the insert is disposed between the sealing ring and the first leg portion of the second sealing leg.

Embodiment 36. The seal or the assembly of any of Embodiments 1 to 35, wherein the seal comprises a plurality of notches disposed through the main body portion of the seal.

Embodiment 37. The seal or the assembly of Embodiment 36, wherein the notches are configured to receive a fastener therethrough or engage a component or feature of an assembly to prevent rotation of the seal within the assembly.

Embodiment 38. The seal or the assembly of any of Embodiments 1 to 37, wherein the main body portion, the first sealing leg, and the second sealing leg are formed from a nickel-chromium based alloy such as Inconel®, a nickel-based alloy, nickel, titanium, tungsten, stainless steel, spring steel, steel, aluminum, zinc, copper, magnesium, tin, platinum, lead, iron, or bronze.

Embodiment 39. The seal or the assembly of Embodiment 38, wherein the main body portion, the first sealing leg, and the second sealing leg comprise a coating.

Embodiment 40. The seal or the assembly of Embodiment 39, wherein the coating comprises an aluminum chromium nitride (AlCrN) coating or a titanium aluminum nitride (TiAlN) coating.

Embodiment 41. The seal or the assembly of any of Embodiments 32 to 40, wherein the sealing ring is formed from a metal or metal alloy.

Embodiment 42. The seal or the assembly of Embodiment 41, wherein the sealing ring is formed from a nickel-chromium based alloy such as Inconel®, a nickel-based alloy, nickel, titanium, tungsten, stainless steel, spring steel, steel, aluminum, zinc, copper, magnesium, tin, platinum, lead, iron, or bronze.

Embodiment 43. The seal or the assembly of Embodiment 42, wherein the ring support comprises a coating.

Embodiment 44. The seal or the assembly of Embodiment 43, wherein the coating comprises a gold strike coating, an aluminum chromium nitride (AlCrN) coating, or a titanium aluminum nitride (TiAlN) coating.

Embodiment 45. The seal or the assembly of any of Embodiments 1 to 44, wherein the seal is configured to be used to seal about a shaft of an assembly having a diameter of about 75 mm to about 200 millimeters.

Embodiment 46. The seal or the assembly of any of Embodiments 1 to 45, wherein a nominal inner diameter (ID) of the seal is at least 1 mm, at least 5 mm, at least 10 mm, at least 25 mm, at least 50 mm, at least 75 mm, at least 100 mm, at least 150 mm, at least 200 mm, at least 250 mm, at least 300 mm, or even greater.

Embodiment 47. The seal or the assembly of any of Embodiments 1 to 46, the nominal outer diameter (OD) of the seal is at least 1 mm, 5 mm, at least 10 mm, at least 25 mm, at least 50 mm, at least 75 mm, at least 100 mm, at least 150 mm, at least 200 mm, at least 250 mm, at least 300 mm, at least 500 mm, or even greater.

Embodiment 48. The seal or the assembly of any of Embodiments 1 to 47, wherein the main body portion comprises a first radial surface and a second radial surface opposite the first radial surface, and wherein the first radial surface and the second radial surface define a nominal axial thickness (TMB) of the main body portion.

Embodiment 49. The seal or the assembly of Embodiment 48, wherein the nominal axial thickness (TMB) of the main body portion is at least 1 mm, at least 2 mm, at least 3 mm, at least 4 mm, at least 5 mm, at least 6 mm, at least 7 mm, at least 8 mm, at least 9 mm, at least 10 mm, at least 15 mm, at least 20 mm, at least 25 mm, or even greater.

Embodiment 50. The seal or the assembly of any of Embodiments 1 to 49, wherein a nominal axial thickness (TS) of the seal is at least 1 mm, at least 2 mm, at least 3 mm, at least 4 mm, at least 5 mm, at least 6 mm, at least 7 mm, at least 8 mm, at least 9 mm, at least 10 mm, at least 15 mm, at least 20 mm, at least 25 mm, or even greater.

Embodiment 51. The seal or the assembly of any of Embodiments 1 to 50, wherein a ratio of the nominal axial thickness (TMB) of the main body portion to the nominal axial thickness (TS) of the seal is at least 1:1.1, at least 1:1.2, at least 1:1.3, at least 1:1.4, or at least 1:1.5.

Embodiment 52. The seal or the assembly of Embodiment 51, wherein the ratio of the nominal axial thickness (TMB) of the main body portion to the nominal axial thickness (TS) of the seal is not greater than 1:3, not greater than 1:2.75, not greater than 1:2.5, not greater than 1:2.25, or not greater than 1:2.

Embodiment 53. The seal or the assembly of any of Embodiments 1 to 52, wherein the first sealing leg is configured to contact and provide a radial seal with at least one bonnet of an assembly.

Embodiment 54. The seal or the assembly of Embodiment 53, wherein the first sealing leg deflects, flexes, or otherwise displaces with respect to the main body portion when the first sealing leg contacts the at least one bonnet.

Embodiment 55. The seal or the assembly of any of Embodiments 1 to 54, wherein the second sealing leg is configured to contact and provide an axial seal with a shaft of an assembly.

Embodiment 56. The seal or the assembly of Embodiment 55, wherein the second sealing leg deflects, flexes, or otherwise displaces with respect to the main body portion when the second sealing leg contacts the shaft.

Embodiment 57. The seal or the assembly of any of Embodiments 1 to 56, wherein the assembly is a valve assembly.

Embodiment 58. The seal or the assembly of Embodiment 57, wherein the assembly is a ball valve assembly.

Embodiment 59. The seal or the assembly of Embodiment 57, wherein the assembly is a subsea valve assembly.

Embodiment 60. A method comprising: providing an assembly having an axis, a shaft, and at least one bonnet disposed annularly about the shaft; providing a seal comprising a metallic annular body, comprising: a main body portion; a first sealing leg extending from the main body portion and configured to provide an axial seal with the at least one bonnet; and a second sealing leg extending from the main body portion and comprising at least one pair of sealing bumps configured to provide a radial seal with the shaft; and disposing the seal within the assembly such that the first sealing leg contacts the at least one bonnet and forms a radial seal with the at least one bonnet and such that the second sealing leg contacts the shaft and forms an axial seal with the at least one shaft.

Embodiment 61. The method of Embodiment 60, wherein disposing the seal within the assembly comprises disposing the seal within an annular cavity formed in the at least one bonnet.

Embodiment 62. The method of Embodiment 61, wherein disposing the seal within the assembly comprises deflecting, flexing, or otherwise displacing at least one of the first sealing leg axially and the second sealing leg radially with respect to the main body portion of the seal.

Embodiment 63. The method of Embodiment 62, wherein disposing the seal within the assembly comprises deflecting, flexing, or otherwise displacing the first sealing leg axially and the second sealing leg radially with respect to the main body portion of the seal.

Embodiment 64. The seal of any of the preceding Embodiments, wherein the seal maintains a substantially constant contact length during subsequent pressure cycles after being subjected to a series of pressure cycles of a pressure of at least 250 bar, at least 500 bar, at least 750 bar, or at least 1000 bar.

Embodiment 65. The seal of any of the preceding Embodiments, wherein the seal demonstrates a reduction in contact length of not greater than 15%, not greater than 14%, not greater than 13%, not greater than 12%, not greater than 11%, not greater than 10%, or even not greater than 5% after being subjected to a series of pressure cycles of a pressure of at least 250 bar, at least 500 bar, at least 750 bar, or at least 1000 bar.

Embodiment 66. The seal of any of the preceding Embodiments, wherein the seal demonstrates an increase in contact length after being subjected to a series of pressure cycles of a pressure of at least 250 bar, at least 500 bar, at least 750 bar, or at least 1000 bar.

Embodiment 67. The seal of any of the preceding Embodiments, wherein the seal demonstrates a substantially constant performance (contact force with respect to pressure) during subsequent pressure cycles.

Embodiment 68. The seal of any of Embodiments 64 to 67, wherein the seal achieves these contact length results and/or constant performance (contact force with respect to pressure) for a minimum number of pressure cycles of at least 3 cycles, at least 4 cycles, at least 5 cycles, at least 10 cycles, at least 25 cycles, at least 50 cycles, at least 100 cycles, at least 500 cycles, or at least 100 cycles.

This written description uses examples to disclose the embodiments, including the best mode, and also to enable those of ordinary skill in the art to make and use the invention. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities may be performed in addition to those described. Still, further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A seal, comprising:
a metallic annular body, comprising:
a main body portion;
a first sealing leg extending from and integral with the main body portion and configured to provide an axial seal; and
a second sealing leg extending from and integral with the main body portion and configured to provide a radial seal.

2. The seal of claim 1, wherein the first sealing leg seals independently of the second sealing leg.

3. The seal of claim 1, wherein the first sealing leg extends from the main body portion adjacent to a first radial surface of the main body portion.

4. The seal of claim 3, wherein the seal comprises a radiused recess adjacent to the first radial surface and the first sealing leg.

5. The seal of claim 1, wherein the first sealing leg extends radially from the main body portion at an angle (α₁) of at least 1 degree, at least 2 degrees, at least 3 degrees, at least 4 degrees, at least 5 degrees, at least 10 degrees, at least 15 degrees, at least 20 degrees, at least 25 degrees, or at least 30 degrees, and wherein the first sealing leg extends from the main body portion at an angle (α₁) of not greater than 45 degrees, not greater than 40 degrees, 35 degrees, not greater than 30 degrees, not greater than 25 degrees, not greater than 20 degrees, or not greater than 15 degrees.

6. The seal of claim 1, wherein the main body portion comprises a first radial surface and a second radial surface opposite the first radial surface, and wherein the first radial surface and the second radial surface define a nominal axial thickness (T_{MB}) of the main body portion, and wherein the first sealing leg extends beyond a nominal axial thickness (T_{MB}) of the main body portion.

7. The seal of claim 1, wherein the first sealing leg forms a radiused cavity with the main body portion adjacent to an outer annular surface of the main body portion.

8. The seal of claim 7, wherein a metallic U-shaped, O-shaped, D-shaped, or C-shaped ring or spring is disposed within the radiused cavity.

9. The seal of claim 1, wherein the second sealing leg comprises a first leg portion that extends radially inward from an inner annular surface of the main body portion.

10. The seal of claim 9, wherein the first leg portion extends orthogonally from the main body portion.

11. The seal of claim 10, wherein the second sealing leg comprises a second leg portion integral with and extending axially from the first leg portion.

12. The seal of claim 11, wherein the second leg portion extends from the first leg portion at an angle (α₂) of at least 1 degree, at least 2 degrees, at least 3 degrees, at least 4 degrees, at least 5 degrees, at least 10 degrees, at least 15 degrees, at least 20 degrees, at least 25 degrees, or at least 30 degrees, and wherein the second leg portion extends from the first leg portion at an angle (α₂) of not greater than 45 degrees, not greater than 40 degrees, 35 degrees, not greater than 30 degrees, not greater than 25 degrees, not greater than 20 degrees, or not greater than 15 degrees.

13. The seal of claim 1, wherein the first sealing leg comprises a tapered width along a length of the first sealing leg, and wherein the second sealing leg comprises a tapered width along a length of the second sealing leg.

14. The seal of claim 1, wherein the second sealing leg comprises at least one pair of sealing bumps, and wherein the sealing bumps extend radially inward from an inner annular surface of the second leg portion.

15. The seal of claim 14, wherein the sealing bumps form annular ridges about the inner annular surface of the second leg portion.

16. The seal of claim 1, wherein the seal comprises a radiused cavity adjacent to a second radial surface of the main body portion and formed by the second sealing leg.

17. The seal of claim 1, wherein the seal comprises a sealing ring assembly, wherein the sealing ring assembly comprises a ring support, a sealing ring, and an insert, and wherein the sealing ring assembly is received within an inner annular cavity that is formed by an inner annular surface of the main body portion and a radial surface of the first leg portion of the second sealing leg.

18. The seal of claim 1, wherein the main body portion, the first sealing leg, and the second sealing leg are formed from a nickel-chromium based alloy such as Inconel®, a nickel-based alloy, nickel, titanium, tungsten, stainless steel, spring steel, steel, aluminum, zinc, copper, magnesium, tin, platinum, lead, iron, or bronze.

19. The seal of claim 18, wherein the main body portion, the first sealing leg, and the second sealing leg comprise a coating.

20. The seal of claim 1, wherein the first sealing leg is configured to contact and provide a radial seal with at least one bonnet of a valve assembly, and wherein the second sealing leg is configured to contact and provide an axial seal with a shaft of the valve assembly.
